(19) United States
(12) Patent Application Publication
(10) Pub. No.: US 2005/0207524 A1
(43) Pub. Date: Sep. 22, 2005

(54) Method for preparing a built-in part of a fuel element of a pressurized water nuclear reactor for disposal, and corresponding conditioned built-in part

(75) Inventors: Klaus Knecht, Tennenlohe (DE); Wolfgang Hummel, Weisendorf (DE)

Correspondence Address: LERNER AND GREENBERG, PA, P O BOX 2480, HOLLYWOOD, FL, 33022-2480, US

(73) Assignee: Framatome ANP GmbH

(21) Appl. No.: 11/039,610

(22) Filed: Jan. 18, 2005

Related U.S. Application Data
(63) Continuation of application No. PCT/EP03/07154, filed on Jul. 4, 2003.

(30) Foreign Application Priority Data
Jul. 18, 2002 (DE) 102 32 596.0

(51) Int. Cl. G21C 7/02

(52) U.S. Cl. 376/209

(57) ABSTRACT

A method for preparing a built-in part for disposal including the steps of mounting a supporting element such that it can be displaced in an axially elastic manner by a spring on a head of the built-in part and being used for support on the grid plate of the head frame of a fuel element. The supporting element is fixed in a pushed-back position against the action of the spring, enabling a common disposal of the built-in part with the fuel element.

### CROSS-REFERENCE TO RELATED APPLICATION

This is a continuing application, under 35 U.S.C. § 120, of copending international application No. PCT/EP2003/007154, filed Jul. 4, 2003, which designated the United States; this application also claims the priority, under 35 U.S.C. § 119, of German patent application No. 102 32 596.0, filed Jul. 18, 2002; the prior applications are herewith incorporated by reference in their entirety.

### BACKGROUND OF THE INVENTION

### FIELD OF THE INVENTION

The invention relates to a method for preparing a built-in part of a fuel element of a pressurized water nuclear reactor, in particular, a control element, for disposal. In addition, the invention relates to a built-in part conditioned for disposal by this method.

The built-in parts of a fuel element of a pressurized water nuclear reactor include, for example, control elements, absorber elements, neutron sources, and throttling elements. These parts are subject to wear, just like other parts of a nuclear plant, which makes it necessary for these to be replaced from time to time. The replaced built-in parts have to be sent for disposal, just like used fuel elements.

### SUMMARY OF THE INVENTION

It is accordingly an object of the invention to provide a method for preparing a built-in part of a fuel element of a pressurized water nuclear reactor for disposal, and corresponding conditioned built-in part that overcome the hereinafore-mentioned disadvantages of the heretofore-known devices and methods of this general type and that can be carried out without difficulty and in which the processing effort required is reduced to a minimum.

With the foregoing and other objects in view, there is provided, in accordance with the invention, a method for preparing a built-in part of a fuel element of a pressurized water nuclear reactor for disposal having a supporting element mounted axially displaceable with a spring within the built-in part to support the built-in part in a sprung manner on the grid plate of a top frame of the fuel element, including the step of fixing the supporting element in a pushed-back position counter to action of the spring.

According to the method, a supporting element that serves to support the built-in part on the upper grid plate of a fuel element and is mounted in a sprung manner such that it can be displaced axially on the top of the built-in part is fixed in a pushed-back position counter to the action of the spring. Such a measure makes it possible to dispose of the built-in part together with a fuel element because the projection of the control element beyond the hold-down springs and the top frame of the fuel element, determined by the axial deflection of the supporting element, is reduced to such an extent by utilizing the available spring travel that the package including the built-in part and fuel element can be introduced for disposal into containers that are originally provided for the transport and storage of fuel elements and are matched to their dimensions. The present invention is based on the finding that the available spring travel of the supporting element is large enough to reduce the projection to an extent that ensures that the clearance intrinsically present in storage and transport containers that are already available and approved is sufficient to accommodate the package, even taking into account growth of the package including fuel element and built-in part induced by radiation and longitudinal expansion caused by a temperature increase in the container.

In accordance with another mode of the invention, the built-in part is inserted into a fuel element so that it rests in a sprung manner on the upper grid plate, at least indirectly. The built-in part is, then, pressed against the grid plate counter to the action of the spring so that the supporting element is pushed back counter to the action of the spring. Such a compressed or pushed-back position is, then, fixed. This measure makes it possible to process the built-in part on site, for example, in the fuel element storage pond, with the handling devices that are available there and supplemented by auxiliary devices in accordance with the method, in particular, the fuel element-loading machine. In such a case, the requirement for additional auxiliary devices is reduced to a minimum because the fuel element, itself, serves as a holder for the built-in part during the conditioning.

In principle, it is possible to fix the entire built-in part in the top frame of the fuel element in this compressed or pushed-back position of the supporting element. However, a fixing is, preferably, provided in which the compressed position is fixed in the built-in part itself so that the built-in part can be removed from the fuel element with the compressed, axially locked supporting element.

For such a purpose, in accordance with a further mode of the invention, before the insertion of the built-in part, a lower holding ring for the supporting element is placed on the upper grid plate of the fuel element (upper top plate) and, in the compressed position, is connected through an axial form fit (axial force fit by a form fit) to an upper holding ring placed on the built-in part. As a result, during the conditioning, no complicated processing operations that lead to material removal from the fuel element or from the built-in part are necessary. Thus, during the conditioning, no nuclear waste arises that would, likewise, again have to be sent for disposal.

In accordance with an added mode of the invention, the supporting element is braced between the upper and lower holding rings.

In accordance with an additional mode of the invention, the upper and lower holding rings are screwed to one another by at least one axial threaded bolt.

In accordance with yet another mode of the invention, the threaded bolt is pre-mounted in the upper holding ring before the upper holding ring is placed on the built-in part.

In accordance with yet a further mode of the invention, the threaded bolt is secured against working loose when the threaded bolt is mounted.

In accordance with yet an added mode of the invention, security against the threaded bolt working loose with a form fit is provided between a head of the threaded bolt and the upper holding plate.

In accordance with yet an additional mode of the invention, the built-in part is pressed against the grid plate with a compression device anchored to the top frame of the fuel element.

In accordance with again another mode of the invention, the built-in part is a control element of the nuclear reactor.

With the objects of the invention in view, there is also provided a method for preparing a built-in part of a fuel element of a pressurized water nuclear reactor for disposal, including the steps of mounting an axially displacing supporting element with a spring on top of a built-in part to support a top frame in a sprung manner on the grid plate of a fuel element and fixing the supporting element in a pushed-back position counter to action of the spring.

With the objects of the invention in view, in a built-in part of a fuel element of a pressurized water nuclear reactor conditioned for disposal, there is also provided a disposal device including a top frame, a grid plate, a spring, and a supporting element mounted by the spring to displace axially in a sprung manner on top of the built-in part and supporting the top frame on the grid plate, the supporting element having a fixing assembly fixing at least one of the top frame and the supporting element in a pushed-back position counter to action of the spring.

In accordance with again a further feature of the invention, there are provided an upper holding ring placed on the built-in part and a lower holding ring for holding the supporting element, the lower holding ring, in a compressed position thereof counter to action of the spring, being connected by an axial form fit to an the upper holding ring.

In accordance with again an added feature of the invention, there is provided at least one axial threaded bolt, the upper and lower holding rings being connected to one another by being screwed to the at least one axial threaded bolt. Preferably, the threaded bolt is secured against working loose.

In accordance with again an additional feature of the invention, the threaded bolt has a head and is secured against working loose by a form fit connection between the head and the upper holding ring.

In accordance with still another feature of the invention, the threaded bolt has an anti-rotation safeguard device preventing the threaded bolt from loosening from the upper and lower holding rings.

In accordance with still a further feature of the invention, the threaded bolt has a head and the anti-rotation safeguard is a form fit connection between the head and the upper holding ring.

In accordance with still an added feature of the invention, the built-in part of the fuel element is a control element of the fuel element of the pressurized water nuclear reactor.

With the objects of the invention in view, there is also provided a package conditioned for disposal, including a fuel element of a pressurized water nuclear reactor and a built-in part connected to the fuel element, the built-in part including a top frame, a grid plate, a spring, and a supporting element mounted by the spring to displace axially in a sprung manner on top of the built-in part and supporting the top frame on the grid plate, the supporting element having a fixing assembly fixing at least one of the top frame and the supporting element in a pushed-back position counter to action of the spring.

In accordance with a concomitant feature of the invention, the built-in part is a control element of the fuel element.

Other features that are considered as characteristic for the invention are set forth in the appended claims.

Although the invention is illustrated and described herein as embodied in a method for preparing a built-in part of a fuel element of a pressurized water nuclear reactor for disposal, and corresponding conditioned built-in part, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary partially cross-sectional and partially side elevational view of a control element inserted into the top frame of a fuel element before its conditioning;

FIG. 2 is a fragmentary partially cross-sectional and partially side elevational view of a control element inserted into the top frame of the fuel element and conditioned in accordance with the invention;

FIG. 3 is a plan view of the fuel element of FIG. 2 provided with the conditioned control element;

FIG. 4 is a cross-sectional view through an auxiliary device according to the invention for the conditioning of the control element;

FIG. 5 is a fragmentary plan view of an upper holding ring according to the invention in the region of the passage hole of the threaded bolt; and

FIG. 6 is a fragmentary, cross-sectional view through a threaded bolt according to the invention in the region of the head of the threaded bolt.

### DESCRIPTION OF THE PREFERRED EMBODIMENTS

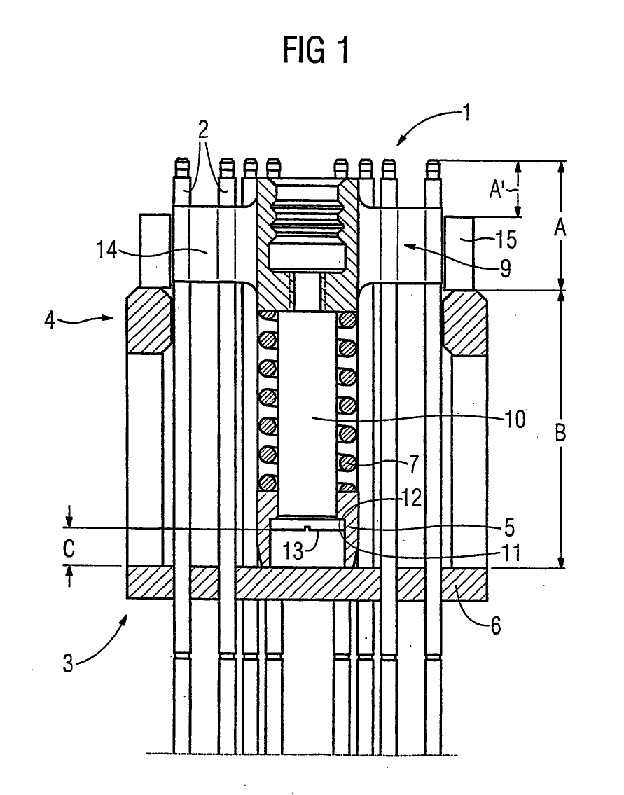

Referring now to the figures of the drawings in detail and first, particularly to FIG. 1 thereof, there is shown a built-in part. A control element 1 in the example, having control rods 2 is inserted into a fuel element 3, of which only the top frame 4 is illustrated in the figure for reasons of clarity. The control element 1 is inserted to the maximum and rests on the grid plate 6 of the top frame 4 by a spring-mounted, sleeve-shaped supporting element 5, having its weight reduced by the buoyancy in water.

The sleeve-shaped supporting element 5 is mounted such that it can be displaced axially by a spring 7 on a stud 10 fixed to the top part 9 of the control element and, in the unloaded state, is secured by a stop face 11 that is disposed at the end of the stud 10 and that corresponds to a corresponding annularly peripheral shoulder face 12 on the inner circumference of the supporting element 5.

The distance C between the upper side of the grid plate 6 of the top frame 4 and the end face 13 of the stud 10 corresponds to the maximum spring or braking travel that is available for the control element 1 falling into the fuel element 3. The dead weight of the control element 1, the spring constant, and the prestress on the spring 7 are dimensioned such that the dead weight of the control element 1 does not lead to a gap between the stop face 11 and the shoulder face 12.

The top part 9 of the control element 1 forms a spider-like carrier having loadbearing arms 14. The control rods 2 are fixed by screw connections to the loadbearing arms 14.

In the state illustrated in FIG. 1, the control element 1 projects by the projection A beyond the top frame 4 and by the projection A′ beyond the hold-down springs 15. This projection A, A′ is, then, too great to dispose of or to store the fuel element 3 together with the control element 1 in a container provided and approved for the fuel element 3. The present invention is based on the thought that the spring travel C is sufficient to shorten the projection A, A′ to such an extent that the fuel element 3 provided with the control element 1 can be introduced into such a container.

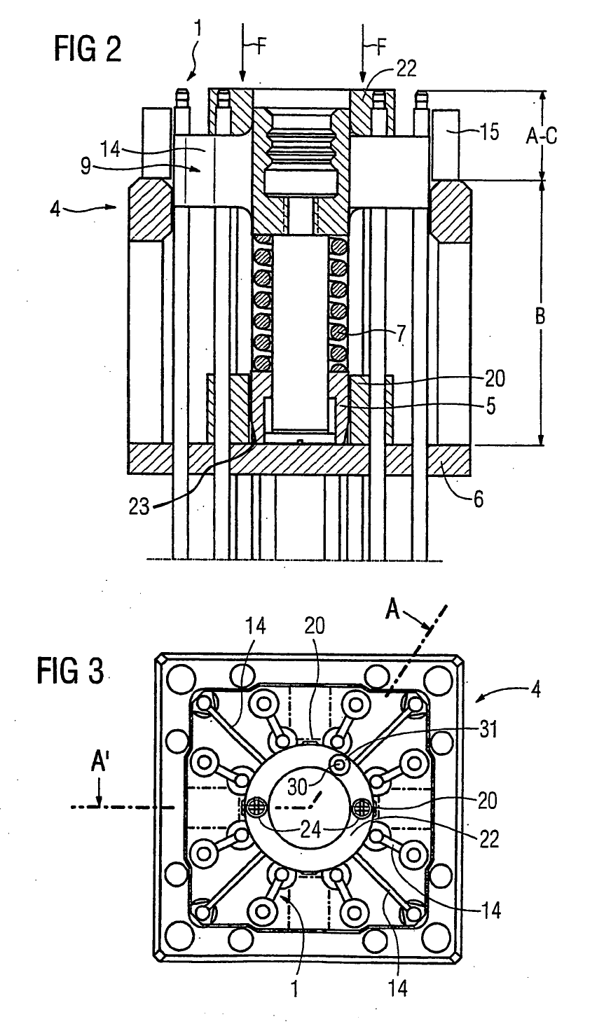

FIG. 2 now shows a situation in which the control element 1 is pressed against the grid plate 6 of the top frame 4 with the force illustrated symbolically by arrows F so that the supporting element 5 is pushed back axially counter to the action of the spring 7. In such a pushed-back or compressed position, the supporting element 5 is fixed so that this position is maintained even if no more force is exerted on the control element. For such a purpose, use is made of a lower holding ring 20 and an upper holding ring 22. The lower holding ring 20 simultaneously forms a seat for the supporting element 5 by a shape matched appropriately to the supporting element 5.

For such a purpose, in the exemplary embodiment, the inner surface of the lower holding ring 20 is shaped conically in the region of the contact face and is matched to the conically shaped outer face 23 of the supporting element 5. The lower holding ring 20, thus, forms a stop for the annular supporting element 5 so that the supporting element 5 can no longer be displaced axially under the action of the spring 7 when the load is relieved if the lower holding ring 20 is fixed relative to the top part of the control element 1. For such a purpose, the lower holding ring 20 is screwed to the upper holding ring 22 resting on the loadbearing arms 14 by threaded bolts that are not visible in the figure.

Instead of a conical seating face, a shoulder, which engages under the supporting element 5, can also be provided on the holding ring so that the end face of the latter rests on the shoulder.

The projection A of the control element 1 beyond the top frame 4 is, then, shortened by the spring travel C in the unstressed state.

In the plan view according to FIG. 3, the upper holding ring 22 resting on the loadbearing arms 14 can be seen. With the aid of two threaded bolts 24, the holding ring 22 is screwed to the lower holding ring 20, which is visible only at its edge. Additionally, the holding rings 20, 22 are each provided with a mounting hole 30, which has an internal thread and a conical insertion chamfer 31. A mounting rod, which makes it possible to handle the holding rings 20, 22 with the aid of a rod-like tool during their mounting, can be screwed into the mounting hole 30.

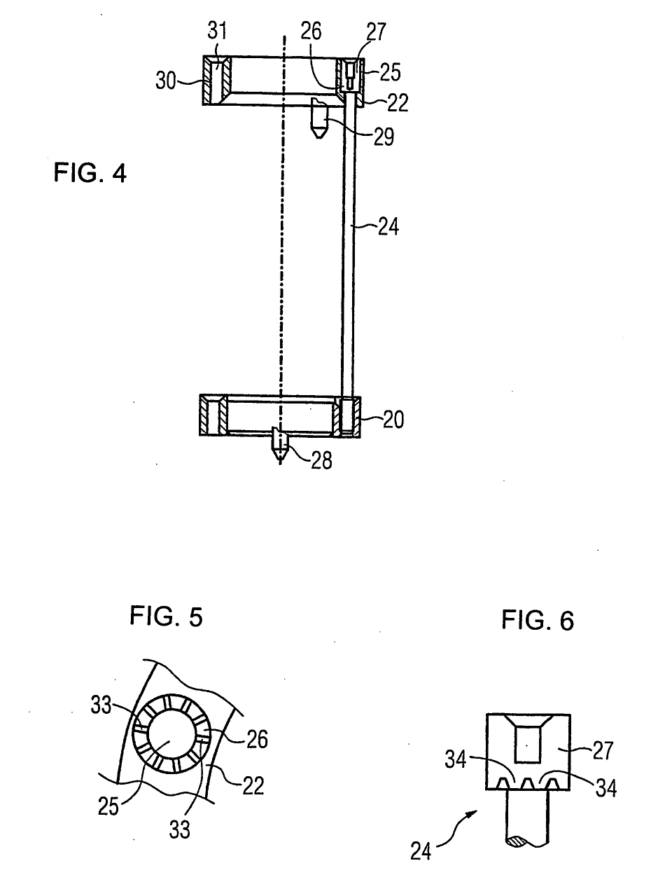

The auxiliary device, assembled from the lower holding ring 20, the upper holding ring 22, and the threaded bolt 24, is illustrated in more detail in FIG. 4. The two holding rings 20, 22 are in each case provided with a pin 28 and 29, respectively, which project into a corresponding recess in the lower grid plate 6 and respectively into a clearance between the loadbearing arms 14 and are used as an anti-rotation safeguard. The passage holes 25 for the threaded bolts 24, disposed in the upper holding ring 22, are stepped and each have an annually peripheral contact shoulder 26, on which the head 27 of the threaded bolt 24 is seated when it is finally mounted. The part of the passage hole 25 having the smaller internal diameter is additionally provided with a thread so that the threaded bolt 24 can be screwed into the upper holding ring 22 to make mounting easier and, together with the upper holding ring 22, can be placed jointly on the control element. As a result, the setting of the threaded bolts 24, which is otherwise retrospectively required, is dispensed with. The lower holding ring 22 is also provided with a mounting hole 30, which makes its handling easier with a mounting rod screwed into the hole.

An advantageous configuration of the holder of the cylindrical head 27 of the threaded bolt 24 in the passage hole 25 in the upper holding ring 22 is illustrated in FIG. 5. Machined into the annular contact shoulder 26 of the passage hole 25 are a large number of radial recesses or grooves 33, which correspond to corresponding moldings or lands 34 that are disposed on the underside of the head 27 of the threaded bolt 24 and can be seen in FIG. 6. Here, the threaded bolt 24 is screwed in as far as possible so that the grooves 33 are aligned with the lands 34 and, when the load is relieved, come into engagement with the latter as a result of the axial resilience due to the spring 7 (see FIGS. 1 and 2), and, in this way, by a form fit between the head 27 of the threaded bolt 24 and the upper holding ring 22, form an anti-rotation safeguard for the threaded bolt 24.

Instead of the screw connection between the upper and lower holding plate explained in the exemplary embodiment, other connections that permit axial fixing can also be provided. The fixing can also been carried out, for example, by a bayonet connection, which is simultaneously formed as an anti-rotation safeguard. In such a variant, the bayonet connection can be provided in the upper or in the lower holding ring.

The conditioning of the control element 1 is carried out under water in accordance with the method sequence set forth in the following text.

First, the lower holding plate 20 is inserted into the fuel element 3 located in the fuel element storage pond with the control element 1 removed, and is placed on the grid plate 6 of the top frame 4 so that the lower holding plate 20 engages with its pin 28 in a passage hole formed in the grid plate 6 and, as such, is secured against rotation. Then, with the aid of the fuel element-loading machine, the control element 1 is inserted into the fuel element 3. Then, the upper holding plate 22, together with the threaded bolts 24 pre-mounted in it, is placed on the top part 9 of the control element 1 with the rod-like tool. With the aid of a compression device, for example, a pneumatic device, which is supported on the upper frame part of the top frame 4, the control element 1 is pressed downward until the end face of the stud 10 is resting on the grid plate 6. In other words, the stud 10 and, therefore, the control element 1 are pressed directly against the grid plate 6.

In the compressed state, the pre-mounted threaded bolts are, then, screwed through the upper holding ring 22 and screwed with their threads into the threaded holes in the lower holding ring 20. The grooves 33 machined into the contact shoulder 26 must, then, be aligned with the corresponding lands 34 on the head 27 of the threaded bolt 24, with the minimum axial distance between holding ring 22 and head of the threaded bolt 24. After the load has been relieved, the lower and upper holding ring 20, 22 are forced apart by the spring 7 by the clearance so that grooves 33 and lands 34 interengage and the threaded bolt 24 is secured against rotation. The stud 10, then, also rises away from the grid plate 6 by this clearance. The threaded bolt 24 is reliably prevented from working loose by the anti-rotation safeguard.

The invention has been explained above using the conditioning of a control element. In principle, however, it can be applied to all the built-in parts of a fuel element of which the top region is constructionally comparable with the control element, are supported in a sprung manner on the upper grid plate and, in the unloaded state, project beyond the hold-down springs.

1. A method for preparing a built-in part of a fuel element of a pressurized water nuclear reactor for disposal having a supporting element mounted axially displaceable with a spring within the built-in part to support the built-in part in a sprung manner on the grid plate of a top frame of the fuel element, comprising:
fixing the supporting element in a pushed-back position counter to action of the spring.

2. The method according to claim 1, which further comprises:
inserting the built-in part into a fuel element to rest in a sprung manner on the grid plate at least indirectly; and
subsequently pressing the built-in part against the grid plate counter to the action of the spring to push back the supporting element.

3. The method according to claim 2, which further comprises, before inserting the built-in part into the fuel element:
placing a lower holding ring for the supporting element on the grid plate of the fuel element; and
connecting the supporting element in a compressed position through an axial form fit to an upper holding ring placed on the built-in part.

4. The method according to claim 3, which further comprises bracing the supporting element between the upper and lower holding rings.

5. The method according to claim 4, which further comprises screwing the upper and lower holding rings to one another by at least one axial threaded bolt.

6. The method according to claim 5, which further comprises pre-mounting the threaded bolt in the upper holding ring before the upper holding ring is placed on the built-in part.

7. The method according to claim 5, which further comprises securing the threaded bolt against working loose when the threaded bolt is mounted.

8. The method according to claim 7, which further comprises providing security against the threaded bolt working loose with a form fit between a head of the threaded bolt and the upper holding plate.

9. The method according to claim 1, which further comprises pressing the built-in part against the grid plate with a compression device anchored to the top frame of the fuel element.

10. The method according to claim 1, wherein the built-in part is a control element of the nuclear reactor.

11. In a built-in part of a fuel element of a pressurized water nuclear reactor conditioned for disposal, a disposal device comprising:
a top frame;
a grid plate;
a spring; and
a supporting element mounted by said spring to displace axially in a sprung manner on top of the built-in part and supporting said top frame on said grid plate, said supporting element having a fixing assembly fixing at least one of said top frame and said supporting element in a pushed-back position counter to action of said spring.

12. The built-in part according to claim 11, further comprising:
an upper holding ring placed on the built-in part; and
a lower holding ring for holding said supporting element, said lower holding ring, in a compressed position thereof counter to action of said spring, being connected by an axial form fit to an said upper holding ring.

13. The built-in part according to claim 12, further comprising at least one axial threaded bolt, said upper and lower holding rings being connected to one another by being screwed to said at least one axial threaded bolt.

14. The built-in part according to claim 13, wherein said threaded bolt is secured against working loose.

15. The built-in part according to claim 14, wherein said threaded bolt has a head and is secured against working loose by a form fit connection between said head and said upper holding ring.

16. The built-in part according to claim 13, wherein said threaded bolt has an antirotation safeguard device preventing said threaded bolt from loosening from said upper and lower holding rings.

17. The built-in part according to claim 16, wherein:
said threaded bolt has a head; and
said antirotation safeguard is a form fit connection between said head and said upper holding ring.

18. The built-in part according to claim 11, wherein the built-in part of the fuel element is a control element of the fuel element of the pressurized water nuclear reactor.

19. A package conditioned for disposal, comprising:
a fuel element of a pressurized water nuclear reactor; and
a built-in part connected to said fuel element, said built-in part including:
a top frame;
a grid plate;
a spring; and
a supporting element mounted by said spring to displace axially in a sprung manner on top of said built-in part and supporting said top frame on said grid plate, said supporting element having a fixing assembly fixing at least one of said top frame and said supporting element in a pushed-back position counter to action of said spring.

20. The built-in part according to claim 19, further comprising:
an upper holding ring placed on the built-in part; and
a lower holding ring for holding said supporting element, said lower holding ring, in a compressed position thereof counter to action of said spring, being connected by an axial form fit to an said upper holding ring.

21. The built-in part according to claim 20, further comprising a at least one axial threaded bolt, said upper and lower holding rings being connected to one another by being screwed to said at least one axial threaded bolt.

22. The built-in part according to claim 21, wherein said threaded bolt has an antirotation safeguard device preventing said threaded bolt from loosening from said upper and lower holding rings.

23. The built-in part according to claim 22, wherein:
said threaded bolt has a head; and
said antirotation safeguard is a form fit connection between said head and said upper holding ring.

24. The built-in part according to claim 19, wherein said built-in part is a control element of said fuel element.

25. A method for preparing a built-in part of a fuel element of a pressurized water nuclear reactor for disposal, comprising:
mounting an axially displacing supporting element with a spring on top of a built-in part to support a top frame in a sprung manner on the grid plate of a fuel element; and
fixing the supporting element in a pushed-back position counter to action of the spring.
